(19) United States
(12) Patent Application Publication
(10) Pub. No.: US 2017/0116956 A1
(43) Pub. Date: Apr. 27, 2017

(54) OPTICAL ADJUSTMENT DEVICE AND OPTICAL ADJUSTMENT METHOD FOR DISPLAY PANEL, AND DISPLAY DEVICE

(71) Applicants: BOE TECHNOLOGY GROUP CO., LTD., Beijing (CN); BOE (HEBEI) MOBILE DISPLAY TECHNOLOGY CO., LTD., Gu'An, Hebei (CN)

(72) Inventors: Guowen YANG, Beijing (CN); Yongjun LIAO, Beijing (CN); Jian LI, Beijing (CN); Jiayin WANG, Beijing (CN); Lantao CHEN, Beijing (CN); Zhen WU, Beijing (CN)

(73) Assignees: BOE TECHNOLOGY GROUP CO., LTD., Beijing (CN); BOE (HEBEI) MOBILE DISPLAY TECHNOLOGY CO., LTD., Gu'An, Hebei (CN)

(21) Appl. No.: 15/101,368

(22) PCT Filed: Dec. 14, 2015
(86) PCT No.: PCT/CN2015/097270

§ 371 Date: Jun. 2, 2016

(30) Foreign Application Priority Data
Apr. 23, 2015 (CN) 201510197718.9

(51) Int. Cl. G09G 5/04; G01N 21/95; G09G 5/02; G09G 5/10; G09G 3/20

(52) U.S. Cl. CPC G09G 5/04; G09G 5/10; G09G 3/2007; G09G 5/028; G01N 21/95; G09G 2320/0626; G09G 2320/0673; G09G 2320/0693; G09G 2320/0666; G09G 3/3208

(57) ABSTRACT

The present disclosure provides an optical adjustment device and an optical adjustment method for a display panel, and a display device. The optical adjustment device includes: an image generation unit configured to display a test image on a to-be-tested display panel, the test image including N monochromatic images corresponding to to-be-tested reference colors, N being an integer greater than 1; an optical detection unit configured to detecting optical parameters of the N monochromatic images simultaneously; and an optical adjustment unit configured to perform optical adjustment on the to-be-tested display panel in accordance with the optical parameters.

### CROSS-REFERENCE TO RELATED APPLICATION

The present application claims a priority of the Chinese Patent Application No. 201510197718.9 filed on Apr. 23, 2015, which is incorporated herein by reference in its entirety.

### TECHNICAL FIELD

The present disclosure relates to the field of optical adjustment technology, in particular to an optical adjustment device and an optical adjustment method for a display panel, and a display device.

### BACKGROUND

Due to material characteristics and process requirements of an organic light-emitting diode (OLED), multiple layers need to be coated during the formation of the OLED, and each layer is very thin. During the coating procedures, uneven layers may occur or impurities may be doped into the layers, resulting uneven light emission. In addition, a conventional organic light-emitting material is of a short service life. Also, it shows insufficient blue (B) and green (G) light emission effects, and its light is usually in a color toward pink, so it is necessary to perform white balance and gamma adjustment on each OLED.

A conventional optical adjustment method for an OLED display panel includes measuring, by an optical device, optical characteristics of the OLED in terms of the red (R), G, B and white (B) colors at different grayscales. However, this method is time-consuming and labor-consuming. Hence, there is an urgent need to provide a method for performing optical adjustment on the display panel more quickly.

### SUMMARY

A main object of the present disclosure is to provide an optical adjustment device and an optical adjustment method for a display panel, and a display device, so as to improve the optical detection efficiency as compared with the related art where optical parameters for a plurality of monochromatic images need to be detected in a time-division manner, thereby to improve the production efficiency.

In one aspect, the present disclosure provides in some embodiments an optical adjustment device for a display panel, including: an image generation unit configured to display a test image on a to-be-tested display panel, the test image including N monochromatic images corresponding to to-be-tested reference colors, N being an integer greater than 1; an optical detection unit configured to detecting optical parameters of the N monochromatic images simultaneously; and an optical adjustment unit configured to perform optical adjustment on the to-be-tested display panel in accordance with the optical parameters.

Alternatively, the optical parameters include brightness, and the optical adjustment unit is further configured to adjust a grayscale of the to-be-tested image, and adjust a gamma voltage in accordance with a gamma curve corresponding to the to-be-tested reference colors, so as to enable a gamma value of the gamma curve to be a calibration gamma value.

Alternatively, the monochromatic images include a red image, a green image and a blue image, the optical parameters include X/Y chromaticity coordinates, and the optical adjustment unit is further configured to perform white balance on the to-be-tested display panel in accordance with the X/Y chromaticity coordinates of the red image, the X/Y chromaticity coordinates of the green image and the X/Y chromaticity coordinates of the blue image.

Alternatively, the optical detection unit includes N optical detection modules, and each optical detection module is configured to detect and process the optical parameters of a corresponding monochromatic image. The optical detection module includes a photoelectric conversion circuit configured to detect the optical parameters of the monochromatic image and convert the detected optical parameters into an analog electric signal, an electric signal amplification circuit configured to amplify the analog electric signal, and a digital-to-analog conversion circuit configured to convert the amplified analog electric signal into a digital signal.

Alternatively, the monochromatic images further include a white image.

Alternatively, the optical adjustment unit is connected to the image generation unit, and configured to adjust the grayscale of the to-be-tested image through the image generation unit.

Alternatively, the image generation unit is a pattern generator (PG).

In another aspect, the present disclosure provides in some embodiments an optical adjustment method for a display panel, including steps of: displaying, by an image generation unit, a test image on a to-be-tested display panel, the test image including N monochromatic images corresponding to to-be-tested reference colors, N being an integer greater than 1; outputting, by an output unit, the test image to the to-be-tested display panel; detecting, by an optical detection unit, optical parameters of the N monochromatic images simultaneously; and performing, by an optical adjustment unit, optical adjustment on the to-be-tested display panel in accordance with the optical parameters.

Alternatively, the optical parameters include brightness, and the step of performing, by the optical adjustment unit, the optical adjustment on the to-be-tested display panel in accordance with the optical parameters includes adjusting a grayscale of the to-be-tested image, and adjusting a gamma voltage in accordance with a gamma curve corresponding to the to-be-tested reference colors, so as to enable a gamma value of the gamma curve to be a calibration gamma value.

Alternatively, the monochromatic images include a red image, a green image and a blue image, the optical parameters include X/Y chromaticity coordinates, and the step of performing, by the optical adjustment unit, the optical adjustment on the to-be-tested display panel in accordance with the optical parameters includes performing, by the optical adjustment unit, white balance on the to-be-tested display panel in accordance with the X/Y chromaticity coordinates of the red image, the X/Y chromaticity coordinates of the green image and the X/Y chromaticity coordinates of the blue image.

In still yet another aspect, the present disclosure provides in some embodiments a display device, including a display panel and the above-mentioned optical adjustment device for performing optical adjustment on the display panel.

According to the embodiments of the present disclosure, a plurality of monochromatic images corresponding to the to-be-tested reference colors may be simultaneously displayed on the to-be-tested display panel by the image generation unit, the optical parameters of the monochromatic images may be detected simultaneously by the optical detection unit, and the optical adjustment may be performed on the to-be-tested display panel by the optical adjustment unit in accordance with the optical parameters. As a result, it is able to improve the optical detection efficiency as well as the production efficiency.

### BRIEF DESCRIPTION OF THE DRAWINGS

FIG. 1A is a block diagram of an optical adjustment device for a display panel according to one embodiment of the present disclosure;

FIG. 1B is another block diagram of the optical adjustment device according to one embodiment of the present disclosure;

FIG. 2 is a block diagram of optical detection modules included in the optical adjustment device according to one embodiment of the present disclosure;

FIG. 3 is yet another block diagram of the optical adjustment device according to one embodiment of the present disclosure; and

FIG. 4 is a flow chart of an optical adjustment method for a display panel according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

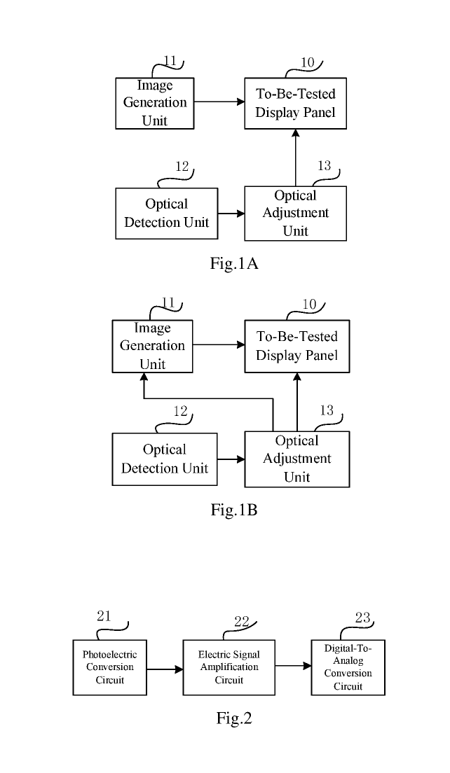

The present disclosure provides in some embodiments an optical adjustment device for a display panel which, as shown in FIG. 1A, includes: an image generation unit 11 configured to display a test image on a to-be-tested display panel 10, the test image including N monochromatic images corresponding to to-be-tested reference colors, N being an integer greater than 1; an optical detection unit 12 configured to detecting optical parameters of the N monochromatic images simultaneously; and an optical adjustment unit 13 configured to perform optical adjustment on the to-be-tested display panel 10 in accordance with the optical parameters.

According to the optical adjustment device in the embodiments of the present disclosure, the N monochromatic images corresponding to the to-be-tested reference colors may be displayed simultaneously on the to-be-tested display panel 10 by the image generation unit 11, the optical parameters of the N monochromatic images may be detected simultaneously by the optical detection unit 12, and the optical adjustment may be performed on the to-be-tested display panel 10 by the optical adjustment unit 13 in accordance with the optical parameters. As a result, it is able to improve the optical detection efficiency as well as the production efficiency.

During the actual application, the image generation unit 11 may display simultaneously a red image, a green image, a blue image and a white image on the to-be-tested display panel 10. The optical detection unit 12 may detect simultaneously the optical parameters corresponding to the red image, the green image, the blue image and the white image. The optical adjustment unit 13 may calculate and process simultaneously the optical parameters of the four monochromatic images detected by the optical detection unit 12. As a result, it is able to perform the optical adjustment on the to-be-tested display panel 10 quickly and efficiently.

Alternatively, the optical parameters include brightness, and the optical adjustment unit is further configured to adjust a grayscale of the to-be-tested image, and adjust a gamma voltage in accordance with a gamma curve corresponding to the to-be-tested reference colors, so as to enable a gamma value of the gamma curve to be a calibration gamma value, thereby to complete the gamma adjustment.

As shown in FIG. 1B, the optical adjustment unit 13 is connected to the image generation unit 11, and configured to adjust the grayscale of the to-be-tested image through the image generation unit 11.

Alternatively, the monochromatic images include a red image, a green image and a blue image, the optical parameters include X/Y chromaticity coordinates, and the optical adjustment unit is further configured to perform white balance on the to-be-tested display panel in accordance with the X/Y chromaticity coordinates of the red image, the X/Y chromaticity coordinates of the green image and the X/Y chromaticity coordinates of the blue image.

To be specific, the optical detection unit may include N optical detection modules, and each optical detection module is configured to detect and process optical parameters of a corresponding monochromatic image.

As shown in FIG. 2, the optical detection module includes a photoelectric conversion circuit 21 configured to detect the optical parameters of the monochromatic image and convert the detected optical parameters into an analog electric signal, an electric signal amplification circuit 22 configured to amplify the analog electric signal, and a digital-to-analog conversion circuit 23 configured to convert the amplified analog electric signal into a digital signal.

During the actual application, the digital-to-analog conversion circuit 23 of the optical detection module outputs the digital signal corresponding to the optical parameters to the optical adjustment unit.

In the embodiments of the present disclosure, the optical adjustment device may perform the gamma adjustment and the white balance on the display panel simultaneously, and it will be described hereinafter in more details.

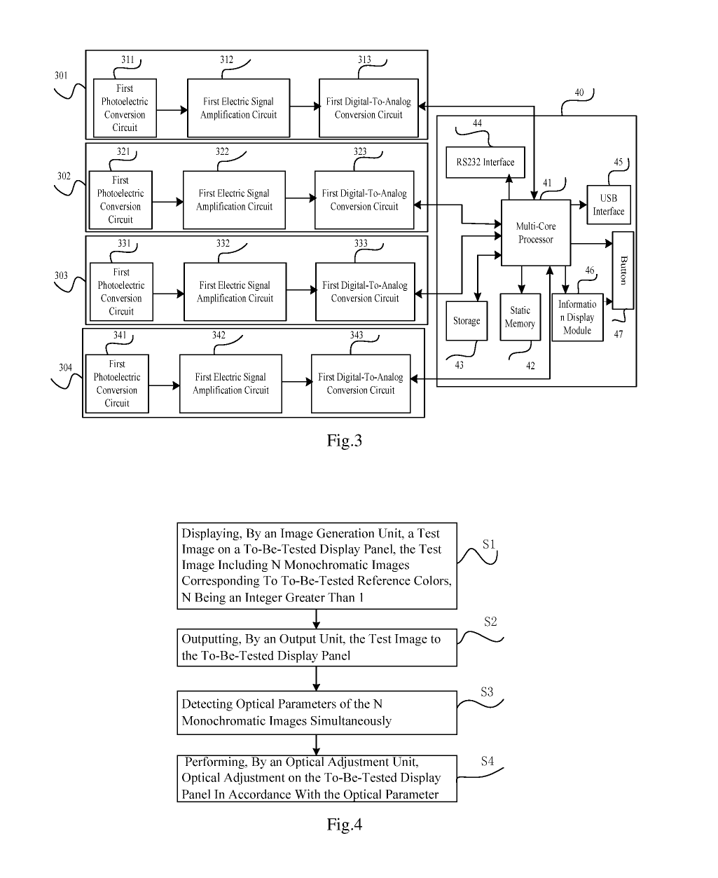

As shown in FIG. 3, the optical adjustment device includes the image generation unit (not shown), the optical detection unit and the optical adjustment unit 40. The image generation unit is configured to display the test image on a to-be-tested OLED display panel (not shown). During the actual application, a pattern generator (PG) may be used as the image generation unit for providing the test image to the OLED display panel. The test image includes a red image, a green image, a blue image and a white image. The optical detection unit is configured to detect the optical parameters of N monochromatic images, and N is an integer greater than 1. The optical adjustment unit 40 is configured to perform the optical adjustment on the to-be-tested OLED display panel in accordance with the optical parameters.

The optical detection unit includes a first optical detection module 301, a second optical detection module 302, a third optical detection module 303 and a fourth optical detection module 304.

The first optical detection module 301 includes a first optical conventional circuit 311, a first electric signal amplification circuit 312 and a first digital-to-analog conversion circuit 313. The first photoelectric conversion circuit 311 is configured to detect the optical parameters of the red image and convert the detected optical parameters into an analog electric signal.

The second optical detection module 302 includes a second photoelectric conversion circuit 321, a second electric signal amplification circuit 322 and a second digital-to-analog conversion circuit 323. The second photoelectric conversion circuit 321 is configured to detect the optical parameters of the green image and convert the optical parameters into an analog electric signal.

The third optical detection module 303 includes a third photoelectric conversion circuit 331, a third electric signal amplification circuit 332 and a third digital-to-analog conversion circuit 333. The third photoelectric conversion circuit 331 is configured to detect the optical parameters of the blue image and convert the detected optical parameters into an analog electric signal.

The fourth optical detection module 304 includes a fourth photoelectric conversion circuit 341, a fourth electric signal amplification circuit 342 and a fourth digital-to-analog conversion circuit 343. The fourth photoelectric conversion circuit 341 is configured to detect the optical parameters of the white image and convert the detected optical parameters into an analog electric signal.

The first photoelectric conversion circuit 311, the second photoelectric conversion circuit 321, the third photoelectric conversion circuit 331 and the fourth photoelectric conversion circuit 341 may be fixed onto a lateral shaft, and positions of the photoelectric conversion circuits on the lateral shaft may be adjusted so as to be adapted to the to-be-tested OLED display panels of different sizes.

During the actual application, the four photoelectric conversion circuits (i.e., optical sensors) may also be connected to a photoelectric circuit board via a flexible data line. The photoelectric circuit board is configured to process the electric signals from the photoelectric conversion circuits, i.e., the four electric amplification circuits and the four digital-to-analog conversion circuits may be integrated into the photoelectric circuit board, with their measurement functions independent of each other. The photoelectric conversion circuits are separated from each other, and their positions and distances therebetween may be adjustable. The photoelectric circuit board includes a signal output interface, and it is connected to the optical adjustment unit via a data line. The signal output interface is configured to output the optical parameters from the four photoelectric conversion circuits. In this way, it is able to facilitate the operation, and to transmit and process the optical parameters simultaneously.

The optical adjustment unit 40 includes a multi-core processor 41 (e.g., a quad-core ARM processor), a static memory 42, a storage 43, an RS232 interface 44, an Universal Serial Bus (USB) interface 45, an information display module 46 and a button 47.

The multi-core processor 41 may calculate and process the data from the four photoelectric conversion circuits. A multiplexer and a Digital Signal Processing (DSP) processor may be integrated into the multi-core processor 41, so as to calculate and process the data quickly. A result of the calculation and processing, i.e., the optical parameters of the OLED display panel, may be stored in the storage 43. In addition, the result may also be outputted to an external device via the RS232 interface 44 or the USB interface. For example, the multi-core processor 41 may be in communication with the PG or a personal computer (PC), so as to transmit the optical parameters to the other devices connected thereto.

The operation of the optical adjustment device will be described hereinafter in more details.

At first, the four separate photoelectric conversion circuits are adjusted to appropriate positions, so as to be adapted to the size of the OLED display panel to be currently tested. The PG outputs a driving signal so as to light up the OLED display panel and generate the test image. The test image includes the red image, the green image, the blue image and the white image.

Each photoelectric conversion circuit is used to detect the optical parameters of the corresponding monochromatic image, and the optical parameters include brightness and X/Y chromaticity coordinates.

The PG automatically adjusts the grayscale of the test image in accordance with settings. Each time the grayscale is adjusted, the photoelectric conversion circuits may detect the brightness of the four monochromatic images. Usually, parts of typical grayscale images may be measured in accordance with the characteristics of the OLED display panel.

Through brightness normalization, a current gamma characteristic of the to-be-tested OLED display panel may be calculated. Because the optical parameters of the red image, the green image, the blue image and the white image have been detected and converted simultaneously, it is able to generate four gamma curves through the brightness normalization (the gamma curves may also be obtained in accordance with the correspondence between the grayscales and the brightness values), which are used to represent the red, green, blue and blue gamma effects of the OLED display panel respectively. On the basis of CIE (Commission Internationale Ed I'eclairage) 1931, color matching may be performed in accordance with the measured X/Y chromaticity coordinates of the red image, the green image and the blue image, so as to determine a white balance effect of the OLED display panel.

The gamma value may be calculated by the equation: gamma value=LOG₁₀(normalized brightness value at current grayscale/(current grayscale value/255)). In addition, normalized brightness value=(current brightness value-darkest brightness value)/(brightest brightness-darkest brightness value).

The PG generates a plurality of grayscale images (each of them includes four monochromatic images) which is displayed on the OLED display panel. The optical parameters of the four monochromatic images are detected by the four separate photoelectric conversion circuits of the optical detection module, and then converted into digital signals. The digital signals are processed by the multi-core processor, so as to calculate a red grayscale brightness value, a green grayscale brightness value, a blue grayscale brightness value and a white grayscale brightness value of the current image as well as the X/Y chromaticity coordinates corresponding thereto. The resultant brightness values and the chromaticity coordinates are stored in the storage. In addition, the multi-core processor is in communication with the PG via the RS232 interface or the USB interface in accordance with a communication protocol, so as to transmit the optical parameters to the PG. Then, the PG receives the brightness values and the chromaticity coordinates, and calculates the gamma value and the white balance effect using certain equations and specifications (e.g., rules or equations for calculating the gamma value, or CIE chromaticity coordinates).

The OLED display panel is driven by a driver integrated circuit (IC). Usually, the driver IC is provided with a gamma register, and a setting value of the gamma register may be changed by the PG, so as to change the display effect and perform the gamma adjustment. A rule and a specification for adjusting the gamma register may be provided by manufacturers.

The white balance adjustment refers to adjusting the red light brightness value, the green light brightness value and the blue light brightness value, so as to mix the red light, the green light and the blue light at a ratio in conformity with an international standard, e.g., CIE1931. The gamma adjustment refers to adjusting the brightness value corresponding to the grayscale image, so as to be adapted to human eyes. Currently, the gamma value of the display device in Asia is set as 2.2.

After the acquisition of the characteristics of the red light, the green light and blue light as well as the gamma curves of the OLED display panel, the gamma register may be adjusted, so as to enable the light-emitting effects of the OLED display panel to approach a predetermined gamma curve, and to achieve the white balance. Different rules and specifications for the gamma register may be provided by different manufacturers, and the value of the gamma register may be set in accordance with the specifications.

In the embodiments of the present disclosure, the optical detection module is used to simultaneously detect the optical parameters, e.g., the brightness and the chromaticity coordinates, of the four monochromatic images. The test image is generated and the parameters of the gamma register are adjusted by the PG. After the adjustment, the optical detection module may detect the optical parameters again, and then the value of the gamma register may be changed, so as to find out the optimum value, thereby to enable the gamma curve to approach or coincide with the predetermined gamma curve and achieve the white balance effect. After the acquisition of the optimum value of the gamma register, it may be recorded in the gamma register in a One-Time Programmable (OTP) or Multi-Time Programmable (MTP) mode, so as to perform the gamma adjustment.

As shown in FIG. 4, the present disclosure further provides in some embodiments an optical adjustment method for a display panel, which includes: Step S1 of displaying, by the image generation unit, the test image on the to-be-tested display panel, the test image including N monochromatic images corresponding to to-be-tested reference colors, N being an integer greater than 1; Step S2 of outputting, by an output unit, the test image to the to-be-tested display panel; Step S3 of detecting the optical parameters of the N monochromatic images simultaneously; and Step S4 of performing, by the optical adjustment unit, optical adjustment on the to-be-tested display panel in accordance with the optical parameters.

According to the optical adjustment method in the embodiments of the present disclosure, a plurality of monochromatic images corresponding to the to-be-tested reference colors may be simultaneously displayed on the to-be-tested display panel by the image generation unit, the optical parameters of the monochromatic images may be detected simultaneously by the optical detection unit, and the optical adjustment may be performed on the to-be-tested display panel by the optical adjustment unit in accordance with the optical parameters. As a result, it is able to improve the optical detection efficiency as well as the production efficiency.

Alternatively, the optical parameters include brightness, and the step of performing, by the optical adjustment unit, the optical adjustment on the to-be-tested display panel in accordance with the optical parameters includes adjusting, by the optical adjustment unit, a grayscale of the to-be-tested image, and adjusting a gamma voltage in accordance with a gamma curve corresponding to the to-be-tested reference colors, so as to enable a gamma value of the gamma curve to be a calibration gamma value.

Alternatively, the monochromatic images include a red image, a green image and a blue image, the optical parameters include X/Y chromaticity coordinates, and the step of performing, by the optical adjustment unit, the optical adjustment on the to-be-tested display panel in accordance with the optical parameters includes performing, by the optical adjustment unit, white balance on the to-be-tested display panel in accordance with the X/Y chromaticity coordinates of the red image, the X/Y chromaticity coordinates of the green image and the X/Y chromaticity coordinates of the blue image.

The present disclosure further provides a display device which includes a display panel and the above-mentioned optical adjustment device. The display device may include an OLED display device, or any other display devices.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. An optical adjustment device for a display panel, comprising:
an image generation unit configured to display a test image on a to-be-tested display panel, the test image including N monochromatic images corresponding to to-be-tested reference colors, N being an integer greater than 1;
an optical detection unit configured to detecting optical parameters of the N monochromatic images simultaneously; and
an optical adjustment unit configured to perform optical adjustment on the to-be-tested display panel in accordance with the optical parameters.

2. The optical adjustment device according to claim 1, wherein the optical parameters comprise brightness, and the optical adjustment unit is further configured to adjust a grayscale of the to-be-tested image, and adjust a gamma voltage in accordance with a gamma curve corresponding to the to-be-tested reference colors, so as to enable a gamma value of the gamma curve to be a calibration gamma value.

3. The optical adjustment device according to claim 1, wherein the monochromatic images comprise a red image, a green image and a blue image, the optical parameters comprise X/Y chromaticity coordinates, and the optical adjustment unit is further configured to perform white balance on the to-be-tested display panel in accordance with the X/Y chromaticity coordinates of the red image, the X/Y chromaticity coordinates of the green image and the X/Y chromaticity coordinates of the blue image.

4. The optical adjustment device according to claim 1, wherein the optical detection unit comprises N optical detection modules, and each optical detection module is configured to detect and process optical parameters of a corresponding monochromatic image; and
the optical detection module comprises a photoelectric conversion circuit configured to detect the optical parameters of the monochromatic image and convert the detected optical parameters into an analog electric signal, an electric signal amplification circuit configured to amplify the analog electric signal, and a digital-to-analog conversion circuit configured to convert the amplified analog electric signal into a digital signal.

5. The optical adjustment device according to claim 1, wherein the monochromatic images further comprise a white image.

6. The optical adjustment device according to claim 1, wherein the optical adjustment unit is connected to the image generation unit, and configured to adjust the grayscale of the to-be-tested image through the image generation unit.

7. The optical adjustment device according to claim 1, wherein the image generation unit is a pattern generator (PG).

8. An optical adjustment method for a display panel, comprising steps of:
displaying, by an image generation unit, a test image on a to-be-tested display panel, the test image including N monochromatic images corresponding to to-be-tested reference colors, N being an integer greater than 1;
detecting, by an optical detection unit, optical parameters of the N monochromatic images simultaneously; and
performing, by an optical adjustment unit, optical adjustment on the to-be-tested display panel in accordance with the optical parameters

9. The optical adjustment method according to claim 8, wherein the optical parameters comprise brightness, and
the step of performing, by the optical adjustment unit, the optical adjustment on the to-be-tested display panel in accordance with the optical parameters comprises adjusting a grayscale of the to-be-tested image, and adjusting a gamma voltage in accordance with a gamma curve corresponding to the to-be-tested reference colors, so as to enable a gamma value of the gamma curve to be a calibration gamma value.

10. The optical adjustment method according to claim 9, wherein the monochromatic images comprise a red image, a green image and a blue image, and the optical parameters comprise X/Y chromaticity coordinates, and
the step of performing, by the optical adjustment unit, the optical adjustment on the to-be-tested display panel in accordance with the optical parameters comprises performing, by the optical adjustment unit, white balance on the to-be-tested display panel in accordance with the X/Y chromaticity coordinates of the red image, the X/Y chromaticity coordinates of the green image and the X/Y chromaticity coordinates of the blue image.

11. A display device, comprising a display panel and the optical adjustment device according to claim 1 for performing optical adjustment on the display panel.

12. The optical adjustment device according to claim 2, wherein the optical detection unit comprises N optical detection modules, and each optical detection module is configured to detect and process optical parameters of a corresponding monochromatic image; and
the optical detection module comprises a photoelectric conversion circuit configured to detect the optical parameters of the monochromatic image and convert the detected optical parameters into an analog electric signal, an electric signal amplification circuit configured to amplify the analog electric signal, and a digital-to-analog conversion circuit configured to convert the amplified analog electric signal into a digital signal.

13. The optical adjustment device according to claim 3, wherein the optical detection unit comprises N optical detection modules, and each optical detection module is configured to detect and process optical parameters of a corresponding monochromatic image; and
the optical detection module comprises a photoelectric conversion circuit configured to detect the optical parameters of the monochromatic image and convert the detected optical parameters into an analog electric signal, an electric signal amplification circuit configured to amplify the analog electric signal, and a digital-to-analog conversion circuit configured to convert the amplified analog electric signal into a digital signal.

14. The optical adjustment device according to claim 2, wherein the optical adjustment unit is connected to the image generation unit, and configured to adjust the grayscale of the to-be-tested image through the image generation unit.

15. The optical adjustment device according to claim 2, wherein the image generation unit is a PG.

16. The optical adjustment device according to claim 3, wherein the optical adjustment unit is connected to the image generation unit, and configured to adjust the grayscale of the to-be-tested image through the image generation unit.

17. The optical adjustment device according to claim 3, wherein the image generation unit is a PG.

18. The display device according to claim 11, wherein the optical parameters comprise brightness, and the optical adjustment unit is further configured to adjust a grayscale of the to-be-tested image, and adjust a gamma voltage in accordance with a gamma curve corresponding to the to-be-tested reference colors, so as to enable a gamma value of the gamma curve to be a calibration gamma value.

19. The display device according to claim 11, wherein the monochromatic images comprise a red image, a green image and a blue image, the optical parameters comprise X/Y chromaticity coordinates, and the optical adjustment unit is further configured to perform white balance on the to-be-tested display panel in accordance with the X/Y chromaticity coordinates of the red image, the X/Y chromaticity coordinates of the green image and the X/Y chromaticity coordinates of the blue image.

20. The display device according to claim 11, wherein the optical detection unit comprises N optical detection modules, and each optical detection module is configured to detect and process optical parameters of a corresponding monochromatic image; and
the optical detection module comprises a photoelectric conversion circuit configured to detect the optical parameters of the monochromatic image and convert the detected optical parameters into an analog electric signal, an electric signal amplification circuit configured to amplify the analog electric signal, and a digital-to-analog conversion circuit configured to convert the amplified analog electric signal into a digital signal.
